(19) United States
(12) Patent Application Publication
(10) Pub. No.: US 2023/0001576 A1
(43) Pub. Date: Jan. 5, 2023

(54) ADAPTIVE MOBILE MANIPULATION APPARATUS AND METHOD

(71) Applicant: Delta Electronics Int'l (Singapore) Pte Ltd, Singapore (SG)

(72) Inventors: Yuh-Rong Chen, Singapore (SG); Guoqiang Hu, Singapore (SG); Chia Loon Cheng, Singapore (SG)

(21) Appl. No.: 17/673,559

(22) Filed: Feb. 16, 2022

Related U.S. Application Data
(60) Provisional application No. 63/217,109, filed on Jun. 30, 2021.

(51) Int. Cl. B25J 9/16; G05D 1/02; B25J 5/00

(52) U.S. Cl. CPC B25J 9/1612; G05D 1/0234; B25J 5/00; B25J 9/1664; B25J 9/1697; G05B 2219/39001; G05B 2219/40519

(57) ABSTRACT

An adaptive manipulation apparatus and method are provided. The adaptive manipulation method includes steps of providing a mobile manipulation apparatus comprising a manipulator, a sensor and a processor for a manipulation of an object placed on a carrier having a plurality of markers spaced apart from each other, the sensor detecting the plurality of markers to obtain a run time marker information, the processor, according to the base-case motion plan, generating a run time motion plan, wherein the run time motion plan comprises a plurality of second pose-aware actions, and the plurality of second pose-aware actions are modified from the plurality of first pose-aware actions according to the run time marker information, and the processor further executing the run time motion plan for controlling the manipulator to manipulate the object.

### CROSS-REFERENCE TO RELATED APPLICATION

This application claims the benefit of U.S. Provisional Application Ser. No. 63/217,109 filed on Jun. 30, 2021, the disclosure of which is incorporated herein by reference.

### FIELD OF THE INVENTION

The present invention relates to an adaptive mobile manipulation apparatus and method, and more particularly to an adaptive mobile manipulation apparatus and method utilizing a plurality of markers.

### BACKGROUND OF THE INVENTION

Material handling and logistics are two important tasks in warehouses and factories. These tasks are usually performed by manpower, which leads to safety risks and operation costs. With the development of mobile manipulator, it is now possible to automate these tasks. However, challenges remain.

The first challenge is the navigation of a mobile manipulator. With the help of LASER range scanners, or LIDAR, and advanced control algorithms, an Automated Guided Vehicle (AGV) is now able to move to a target location. However, the accuracy is about 10 centimeters in position and about 10 degrees in orientation.

The second challenge is the localization of the target object or manipulating area, which involves estimating its pose, including the position and the orientation thereof. Techniques such as computer vision and machine learning are capable of doing this in limited conditions such as good lighting. However, due to the placement of camera(s) on the mobile manipulator and various lighting conditions in the warehouse or factory, the outcome is not stable. Besides, these techniques are computationally intensive and not suitable for a mobile manipulator, which has limited battery power and computational power. If the manipulation scenario changes, the mathematical models also have to be re-established. Techniques using squared planar fiducial markers such as ArUco and ALVAR are popular methods used to detect the markers' poses by placing the marker on the object. Given the size of a square marker, the position and orientation of the marker, namely, the pose of the marker, can then be determined by its size and shape in the camera image. The resulting position estimation is accurate (usually within one or two millimeters), but the orientation estimation heavily depends on environmental conditions such as lighting and fluctuates within a short period of time.

The third challenge is about motion planning. This includes moving the mobile manipulator to a specific location and using the manipulator to perform manipulation task. Traditionally, “teaching” is the technique used on production line for a fixed manipulator to perform repetitive tasks such as pick and place, screwing. An engineer guides and programs the manipulator through a sequence of movements that represent the task. However, due to the position and orientation errors from moving the mobile platform (AGV), there exists a position offset and an orientation offset from the manipulator to the target and this makes traditional “teaching” technique not suitable for a mobile manipulator.

In addition to the above-mentioned challenges, artificial intelligence and machine learning are popular techniques for solving the above-mentioned problems in academic research. However, it can be practically infeasible for small businesses to have a team of researchers focused on this due to the financial cost. It is appropriate to provide a low-cost framework to solve this problem.

Therefore, there is a need of providing an adaptive mobile manipulation apparatus and method distinct from prior art in order to solve the above drawbacks.

### SUMMARY OF THE INVENTION

The present disclosure provides an adaptive mobile manipulation apparatus and method in order to overcome at least one of the above-mentioned drawbacks.

The present disclosure also provides an adaptive manipulation method which classifies the actions for object manipulation into pose-aware actions and non-pose-aware actions and further associates the pose-aware actions with localization information obtained by detecting the markers, and thus, the pose-aware actions with high accuracy can be achieved through a low-cost framework of an adaptive mobile manipulation apparatus.

In accordance with an aspect of the present disclosure, an adaptive manipulation method is provided. The adaptive manipulation method includes steps of providing a mobile manipulation apparatus including a manipulator, a sensor and a processor for a manipulation of an object placed on a carrier having a plurality of markers spaced apart from each other, providing a base-case motion plan including a plurality of first pose-aware actions, the sensor detecting the plurality of markers to obtain a run time marker information, the processor, according to the base-case motion plan, generating a run time motion plan, wherein the run time motion plan includes a plurality of second pose-aware actions, and the plurality of second pose-aware actions are modified from the plurality of first pose-aware actions according to the run time marker information, and the processor further executing the run time motion plan for controlling the manipulator to manipulate the object.

In an embodiment, each of the first pose-aware actions of the base-case motion plan includes variables and a base-case marker information corresponding to the plurality of markers.

In an embodiment, the method further includes steps of the processor calculating a difference between the base-case marker information and the run time marker information, and the processor generating the plurality of second pose-aware actions according to the plurality of first pose-aware actions and the difference.

In an embodiment, both the run time marker information and the base-case marker information include positions and orientations between the plurality of markers and the sensor.

In an embodiment, the manipulator further includes an end effector and a joint. The first and the second pose-aware actions include moving the end effector by position and orientation relative to the object. The first and the second pose-aware actions respectively further include at least one of the following: moving the end effector to a target pose, traversing the end effector through a trajectory, and moving the end effector associating with the run time marker information.

In an embodiment, the object is placed at a fixed location on the carrier. In another embodiment, the markers include visual markers or fiducial markers. In further another embodiment, the sensor includes a camera.

In accordance with another aspect of the present invention, an adaptive manipulation apparatus is provided. The adaptive mobile manipulation apparatus includes a manipulator, a sensor, and a processor. The processor is coupled to the manipulator and the sensor, and configured to perform the following steps: retrieving a base-case motion plan including a plurality of first pose-aware actions, driving the sensor to detect a plurality of markers located on a carrier to obtain a run time marker information, according to the base-case motion plan, generating a run time motion plan, wherein the run time motion plan includes a plurality of second pose-aware actions, and the plurality of second pose-aware actions are modified from the plurality of first pose-aware actions according to the run time marker information, and executing the run time motion plan for controlling the manipulator to manipulate an object placed on the carrier.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 schematically illustrates the design of an adaptive mobile manipulation system;

FIG. 2 schematically illustrates the basic architecture of an adaptive mobile manipulation apparatus;

FIG. 3 schematically illustrates the flow chart of a motion plan;

FIG. 4 schematically illustrates the setup of a manipulating workspace;

FIG. 5 schematically illustrates the setup of a camera sensor and markers;

FIG. 6 schematically illustrates the implementation flow chart for creating a base-case motion plan;

FIG. 7 schematically illustrates the execution flow chart of a motion plan at run time;

FIG. 8 schematically illustrates the flow chart of a manipulation process for manipulating a target object;

FIG. 9 schematically illustrates the process of obtaining marker information from a camera sensor;

FIG. 10 schematically illustrates the marker positions in the base-case motion plan and the run time motion plan; and

FIG. 11 schematically illustrates the idea of calculating position and orientation offsets.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

The present disclosure is to provide a framework for object manipulation (picking up, placing, or modifying objects etc.) in the settings of warehouses or factory production lines, such that an engineer or operator can easily design a motion plan with affordable financial cost.

Four parts of the details of the present disclosure, including (1) the design of system, (2) the architecture of an adaptive manipulation apparatus, (3) the design of a teaching-based adaptive mobile manipulation, and (4) the algorithms used to obtain localization information from multiple markers, will be described as following.

(1) The Design of System

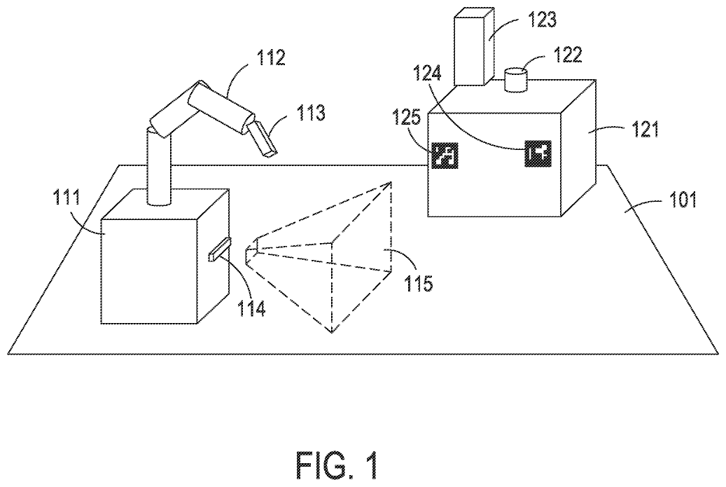

The system includes the physical setup of the environment, including an adaptive mobile manipulation apparatus, a carrier for placing a target object, and markers placed on the carrier and spaced apart from each other. Generally, the carrier is the rigid body shelf in the warehouse or factory and different shelves are distinguished by their identification numbers, i.e. shelf ID. Please refer to FIG. 1. FIG. 1 schematically illustrates the design of an adaptive mobile manipulation system. The adaptive mobile manipulation system includes three main components, which are (a) the floor (ground) 101 of the warehouse or the factory, (b) an adaptive mobile manipulation apparatus includes an AGV component 111, a manipulator 112 with a manipulating tool 113, a sensor 114 with the numeral symbol 115 representing the effective view volume of the sensor 114, and (c) a carrier 121, a target object 122, collision objects 123, and markers 124, 125. Depending on different environmental settings and practical demands, the sensor 114 can be a camera sensor, such as 2D/RGB camera, and the markers 124, 125 can be, e.g., visual or fiducial markers, without limitation.

The carrier 121 is specially designed to house the target object 122. Hence, it is assumed that the relative poses among the carrier 121, the target object 122, the collision objects 123 and the markers 124, 125 are fixed. The poses of other components can be calculated from the pose of the carrier 121 if the latter is known. Two markers 124, 125 are positioned horizontally on the carrier 121 facing approximately in the same direction at the approximately same height from the ground 101. For best result, it is suggested that (a) the marker is at least 35 mm in size, (b) additional white-color border of at least 3 mm wide surrounding each marker, and (c) 100 mm apart from each other measured from their centers.

Although there are only one adaptive mobile manipulation apparatus and only one carrier are shown in FIG. 1, it is just for illustration. There could be many of them (could be different types) in the operating area. There could also be multiple pairs of markers on a single carrier for manipulation in different directions or different types of mobile manipulation apparatuses.

The objective of a “manipulation task” is to move the mobile manipulation apparatus to a location near the carrier 121 and perform manipulation at the target object 122. Hence, before performing manipulation, the AGV component 111 of the adaptive mobile manipulation apparatus moves to a pose nearby the carrier 121 with a specific pair of markers within the effective view volume 115 of the sensor 114 of the mobile manipulation apparatus, and the target object 122 is within the reach of the manipulator 112 using existing navigation techniques.

Accordingly, the following reasonable assumptions are made. Firstly, the manipulation task is divided into two steps—navigation (using the AGV component 111) and manipulation (using the manipulator 112). Secondly, the AGV component 111 is able to navigate to a target position and orientation accurately enough such that the target object 122 is within the reach of the manipulator 112. However, a margin of error (position and orientation offsets) is allowed. Lastly, the target object 122 is placed on a specially designed carrier 121 and hence the related poses of the target object 122 are fixed with the carrier 121. In other words, with the knowledge of the pose of the carrier 121, the pose of the target object 122 can be calculated.

(2) The Basic Architecture of an Adaptive Mobile Manipulation Apparatus

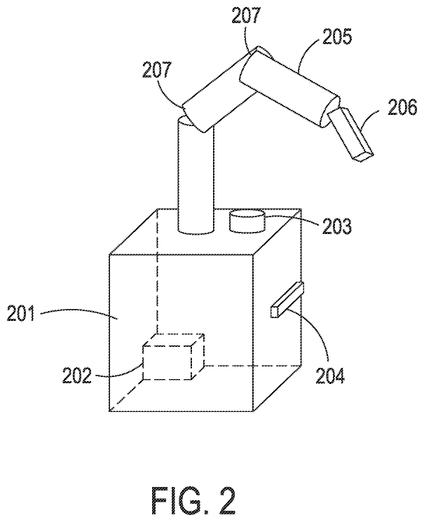

Please refer to FIG. 2. FIG. 2 schematically illustrates the basic architecture of an adaptive mobile manipulation apparatus. This architecture, which is commonly seen in industrial mobile manipulation apparatuses, includes the following components that are electrically coupled: an AGV component 201, a processor 202, ranging devices 203, a sensor 204, and a manipulator 205 with an end effector (EFF) 206 and at least a joint 207, wherein the processor 202 is configured to perform the computing and communication for manipulating the target object. The present disclosure mainly focuses on the manipulation and hence only the processor 202, the sensor 204, the manipulator 205, and the EFF 206 are described.

(3) Teaching-Based Adaptive Manipulation

(3.1) Motion Plan

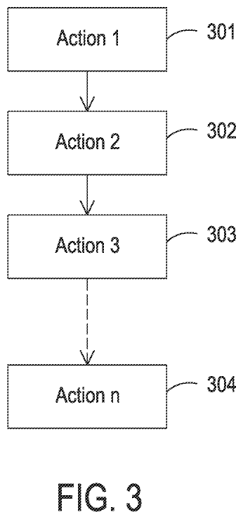

Following the paragraphs described above, the manipulation task is defined as using the manipulator to manipulate objects without direct physical contact by the human labor after the adaptive mobile manipulation apparatus has reached the pose for manipulation. The manipulation task includes a series of manipulation actions and can be defined as a “motion plan”. Please refer to FIG. 3, which schematically illustrates the flow chart of a motion plan with n steps. The steps transit from Action 1 301 to Action 2 302, to Action 3 303, and so on until Action n 304. Possible actions include, but are not limited to, (a) moving to a target joint state, (b) moving EFF to a target pose, (c) EFF traversing through a trajectory, (d) EFF moving with a position offset with respect to the coordinate of the manipulator, (e) EFF moving with a position offset with respect to the coordinate of the target object, and (f) tool action (e.g., open/close gripper) or other related actions (e.g., light on/off, conveyor on/off). Note that a series of (b) form a “trajectory” for (c). In the motion plan, there could also be collision objects, which are the objects in the scene that could collide with the manipulator and should be avoided.

Without loss of generality, only the actions listed below in the Table I are considered in the present disclosure. The possible actions in a motion plan are classified by pose-awareness. The actions which are classified as pose-aware are those directly related to the manipulation of the target object after the manipulator and the EFF are within a range capable of reaching the target object. Note that it is possible to have actions with online adjustment using wrist camera or other sensors, which can be combined with this framework.

TABLE I
Possible actions in a motion plan

| Pose-awareness | Action | Variable Required |
|---|---|---|
| Pose-aware | Moving EFF to a pose | Target EFF pose, |
| | | Marker positions |
| | EFF traversing through a | Trajectory, |
| | trajectory | Marker positions |
| | EFF moving with | Position offset, |
| | position offset | Marker |
| | with respect to | positions |
| | target object's | |
| | coordinate | |
| Non pose- | Moving to a joint state | Joint state (angles) |
| aware | EFF moving with | Position offset |
| | position offset | |
| | with respect to | |
| | manipulator's | |
| | coordinate | |
| | Tool and other actions | Control variables |

(3.2) Creating a Base-Case Motion Plan Using “Teaching” and its Implementation

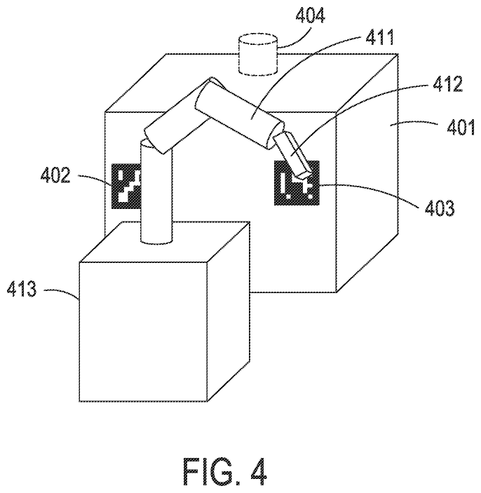

Please refer to FIG. 4. FIG. 4 schematically illustrates the setup of a manipulating workspace. As shown, the numeral symbol 401 indicates the carrier, e.g. the rigid body shelf, the numeral symbols 402 and 403 indicate two squared fiducial markers, the numeral symbol 404 indicates the target object, the numeral symbols 411 and 412 respectively indicate the manipulator and the EFF, and the numeral symbol 413 indicates the AGV component. It can be observed that the relative pose between the target object 404 and the rigid body shelf 401 is fixed. However, the relative poses between the manipulator 411 and the EFF 412 with the rigid body shelf 401 and the target object 404 depend on the pose (position and orientation) of the mobile manipulation apparatus.

However, if a motion plan for such manipulation task for a specific mobile manipulation pose configuration is provided, this motion plan is able to be modified for other different mobile manipulation pose configurations. This motion plan is defined as the “base-case motion plan” and the purpose of “teaching” is to create it. A base-case motion plan can be designed manually, computationally, or through teaching. This section covers the process to create the base-case motion plan using teaching and its implementation.

(3.2.1) Environmental Setup

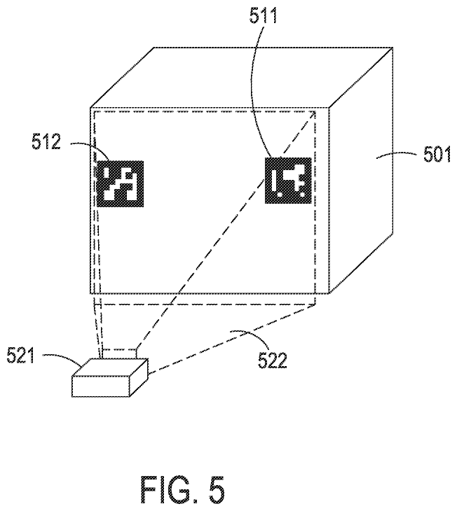

In order to apply position and orientation fixes to adjust actions in the base-case motion plan, additional information needs to be captured for the base-case motion plan. In the present disclosure, each pose-aware action is associated with a pair of fiducial markers. Hence, as shown in FIG. 5, which schematically illustrates the setup of the camera sensor and markers, a pair of fiducial markers 511, 512 must be within the effective view volume 522 of the camera sensor 521 once the adaptive mobile manipulation apparatus stops moving. In practice, a single pair of markers can be associated with the entire base-case motion plan. Without loss of generality, it is also possible to use different pairs of markers for different actions, which will be considered in this disclosure.

(3.2.2) Base-Case Motion Plan and its Digital Representation

Given an arbitrary mobile manipulator pose, a motion plan to perform the manipulation task can be modified into a base-case motion plan by adding marker information to each pose-aware action. Hence, to create a base-case motion plan, an additional step is required to detect the pair of markers to obtain base-case marker information for being associated with each pose-aware action. This can be done by using squared fiducial marker technique. Such technique can provide a stream of estimated poses (position and orientation) of a marker using the image frames come from an RGB camera. However, the values could be fluctuating, and a filter that can be applied to the pose stream is presented in a latter section and is designed to improve the detections. The following Table II shows the data structures used in actions and how different types of variables are represented in a computer system.

TABLE II
Actions and their digital representation

| Variable | Data structure | Explanation |
|---|---|---|
| EFF pose | ((x, y, z), | A tuple consists of position and |
| | (rx, ry, rz, rw)) | orientation |
| Trajectory | [P₁, P₂, . . . , Pₖ] | An array pf Pᵢ's, each Pᵢ is |
| | | an EFF pose |
| Position | (x, y, z) | Position offset with respect to |
| offset | | manipulator's coordinate |
| Joint state | [j₁, j₂, . . . , jₖ] | An array of joint angles, size |
| | | depends on the number |
| | | of joints of a |
| | | manipulator |
| Control | N/A | Depends on the |
| variables | | semantic scenario, |
| | | not a scope of the |
| | | present disclosure |
| Marker | {n_{L}: (x, y, z), | A tuple consists of |
| positions | n_{R}: (x, y, z)} | two marker ids |
| | | and their positions |

1. x, y, z, rx, ry, rz, rw are real numbers but usually represented as double precision floating point numbers in a computer system.
2. j₁, j₂, . . . , jₖ are real numbers but can be simplified and represented as double precision floating point numbers in the range between −π and π.
3. n_{L}, n_{R} are left and right marker IDs.

Base on the paragraphs described above, the motion plan defined earlier for a base-case motion plan can be extended as an ordered list of actions with positions of a pair of square fiducial markers stored if the action is pose-aware. The details of the data structures used for a base-case motion plan in a computer system are illustrated below:

Base case motion plan=[a]

a=Pose_{EFF}|Trajectory|Offset_{target}|JS|Offsetₘₐₙᵢₚᵤₗₐₜₒᵣ|Actionₒₜₕₑᵣ

Pose_{EFF}=((p,q), (p_{L}, p_{R}))

Trajectory=([(p,q)], (p_{L}, p_{R}))

Offset_{target}=((x,y,z),(p_{L},p_{R}))

JS=[j]

Offsetₘₐₙᵢₚᵤₗₐₜₒᵣ=(x,y,z)

p,p_{L},p_{R}=(x,y,z)

q=(rx, ry, rz, rw)

x,y,z,rx,ry,rz,rw,j are real numbers.

The notations used in former paragraphs are as follows:

[u]: an ordered list of “u”

a: an action

|: or

Pose_{EFF}: EFF Pose

Trajectory: EFF Trajectory

Offset_{target}: EFF movement offset along target object's coordinate

JS: manipulator's joint state

Offsetₘₐₙᵢₚᵤₗₐₜₒᵣ: EFF movement offset along manipulator's coordinate

Actionₒₜₕₑᵣ: other actions that does not affect the manipulator state

p,p_{L},p_{R}: position, position of left marker, position of right marker

q: orientation (Euler angles or quaternion)

Note that without loss of generality, it is assumed the origin (0, 0, 0) and the world coordinate system are aligned with the base of the manipulator.

(3.2.3) Create Base-Case Motion Plan Using Teaching

When doing manipulator onboard programming, teaching is used to specify a state (mostly a joint state) by moving the manipulator to a desired configuration instead of giving the values of this joint state. In the present disclosure, this concept is extended further to the entire motion plan and the user guides the manipulator through a series of actions during this process.

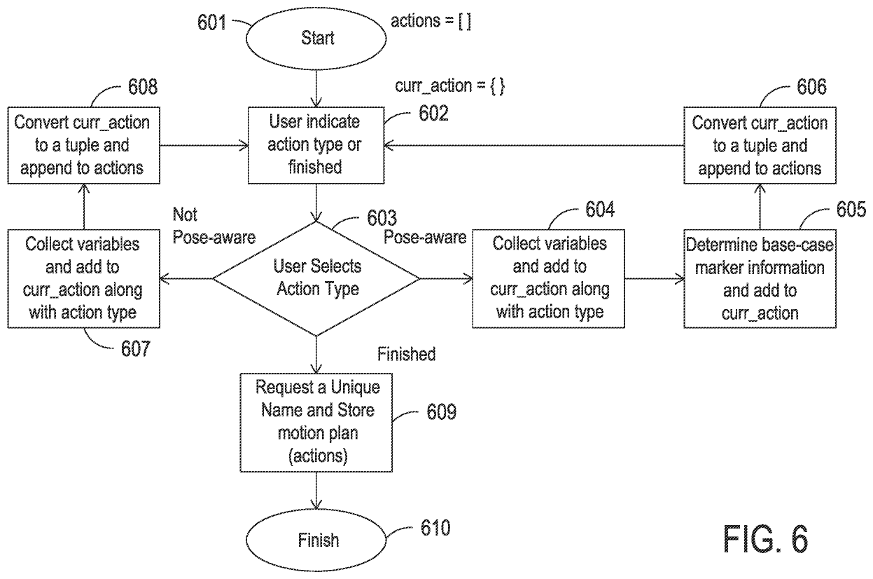

Please refer to FIG. 6. FIG. 6 schematically illustrates the implementation flow chart of a teaching technique for creating the base-case motion plan. At the beginning of teaching 601, an empty ordered list “actions” is initialized to store the motion plan. Next, as shown in step 602, the user indicates the next action in the motion plan, or the user has finished creating the motion plan. Meanwhile, a dictionary data structure ({ }) “curr_action” is initialized as empty. In the decision step 603, user input from previous step 602 is checked.

If the action is a pose-aware action, corresponding variables from Table II are collected in step 604 and stored into “curr_action” along with the type of the action. In this step, these variables can be collected directly from the manipulator after the user operates the manipulator to the desired pose. Next step 605 is to collect the base-case marker information from left and right markers using known technique described earlier and the base-case marker information is stored in “curr_action” along with marker IDs, in which marker IDs are given by the user. An algorithm that collects a series of samples and applies a filter to filter out extreme value for providing better values is presented in Section 4.1. Then, “curr_action” is appended to the end of “actions” in step 606. Accordingly, the pose-aware actions associated with the base-case marker information for the base-case motion plan are created and defined as first pose-aware actions.

Similarly, if the action is a non-pose-aware action, corresponding variables from Table II is collected in step 607 and stored into “curr_action” along with the type of the action. In this step, these variables can be collected (1) directly from the manipulator after the user operates the manipulator to the desired joint state, and (2) through user keyboard input (for example, EFF position offset, close/open the gripper, or other options). The system performs corresponding action upon receiving user input, then “curr_action” is appended to the end of “actions” in step 608. Accordingly, the non-pose-aware actions for the base-case motion plan are created and defined as first non-pose-aware actions.

If it indicates that the user has finished creating the base-case motion plan, “actions” is then flattened as a string data structure and stored with a unique name specified by the user for later use in step 609. Then the process moves to the finish state 610.

(3.3) Adjusting Base-Case Motion Plan for Run Time Scenario

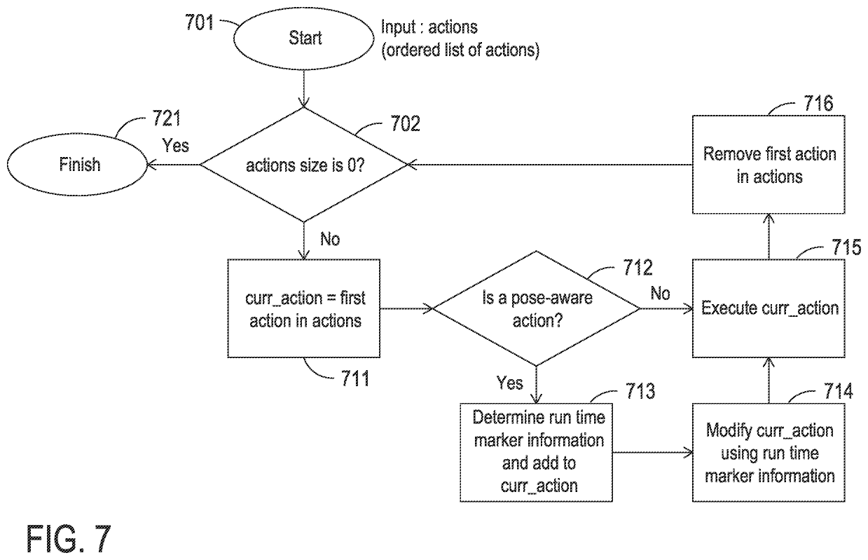

Please refer to FIG. 7. After retrieving a base-case motion plan for a specific scenario, the process to modify it for run time execution is illustrated in FIG. 7. In Step 701, the input is a base-case motion plan with first pose-aware actions and first non-pose-aware actions described in Section 3.2, which can be looked up in the computer storage and identified by its name. Then, go through and process each element (which is an action) in the motion plan. First is to check if the size of actions is 0 as shown in step 702. If it is 0, the process is finished and moved to the finish state 721. Otherwise, retrieve the first element in actions as curr_action 711. Next, determine if this is a pose-aware action as shown in step 712. If this is not a pose-aware action, the action is executed as shown in step 715. Otherwise, the processor drives the sensor to detect the markers specified in this action for obtaining run time marker information using the filter and algorithm in Section 4.1 as shown in step 713. Then, the run time marker information is passed to step 714 to calculate the position and orientation offsets using the algorithms in Section 4.2 and used to modify the action using the algorithms in Section 4.3. Then, the modified action is executed as shown in step 715, the first action in actions is removed as shown in step 716 and actions are processed again using the same flow.

That is, the run time motion plan is modified from the base-case motion plan. First, according to the run time marker information obtained by the sensor, the first pose-aware actions of the base-case motion plan are modified into different pose-aware actions, which are defined as second pose-aware actions in the run time motion plan. Further, the first non-pose-aware actions of the base-case motion plan are not modified and executed directly at run time, which are defined as second non-pose-aware actions in the run time motion plan.

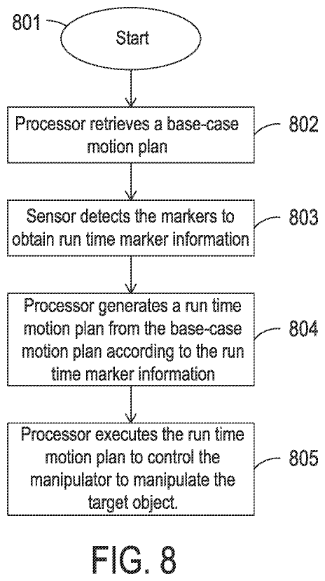

Accordingly, in summary, the process for the adaptive mobile manipulation apparatus to manipulate the target object is as shown in FIG. 8. The process starts at step 801. Then, in step 802, the processor retrieves a base-case motion plan that has already created. Next, the processor drives the sensor to detect the markers for obtaining the run time marker information as in step 803. According to the run time marker information, the processor modifies the base-case motion plan with the first pose-aware actions and the first non-pose-aware action into the run time motion plan with the second pose-aware actions and the second non-pose-aware actions in step 804. Then, as shown in step 805, the run time motion plan is executed, thereby controlling the manipulator to manipulate the target object.

(4) Algorithms for Modifying Base-Case Motion Plan

(4.1) Filtering Algorithm for Getting Stable Marker Positions

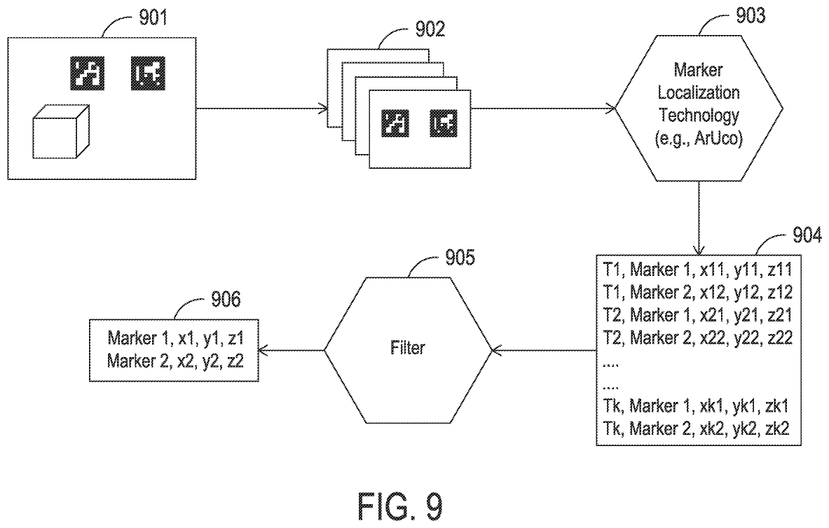

Please refer to FIG. 9. The process of obtaining marker information from the camera sensor is shown in FIG. 9. RGB camera is used to obtain image stream in step 901. Then, the images in the stream as shown in step 902 are processed using existing squared fiducial marker localization techniques such as ArUco or AR Tracker Alvar as shown in step 903. The output from the step 903 is stream of marker ids along with their positions and orientations. Consecutive k data points for each marker are retrieved with orientations removed in step 904. In this implementation, k is set to 300 during teaching and 30 during run time. Then the data from the step 904 is processed by the algorithm in step 905 to filter out extreme values and output in step 906.

The filtering algorithm in step 905 is presented below.

```
    Input:
Pₘ = (pₘ₁,pₘ₂, ... ... ,pₘₖ),∀m ∈ M,pₘᵢ = (xₘᵢ,yₘᵢ,zₘᵢ)
    Algorithm:
$1. Compute {C}_{m}^{1} = ( \frac{{\sum }_{i = 1}^{k} {x}_{mi}}{k} , \frac{{\sum }_{i = 1}^{k} {y}_{mi}}{k} , \frac{{\sum }_{i = 1}^{k} {z}_{mi}}{k} ) , ∀ {P}_{m}$
          $q = [ \frac{k}{2} ]$
2. Sort Pₘ by their distances to Cₘ¹ in ascending order
3. Let Pₘ′ be the first q element from sorted Pₘ in previous step
$4. Compute {C}_{m} = ( \frac{{\sum }_{i = 1}^{q} {x}_{mi}}{q} , \frac{{\sum }_{i = 1}^{q} {y}_{mi}}{q} , \frac{{\sum }_{i = 1}^{q} {z}_{mi}}{q} ) , ∀ {P}_{m}^{′}$
    Output:
Cₘ = (xₘ,yₘ,zₘ),∀m ∈ M
```

The notations used in former paragraphs are as follows:

M: the set of markers to be localized

m: marker m

Pₘ: the k samples for a specific marker m

pₘᵢ: i-th sample in Pₘ with position (xₘᵢ, yₘᵢ, zₘᵢ)

Cₘ: final position for marker m

Other notations for temporal variables are self-explanatory

The output from the filtering algorithm is then used to modify the base-case motion plan.

Note that by placing 3 markers in an L shape (or more markers), it will be able to determine position offset in 3-dimension as well as Roll/Pitch/Yaw. Above information can then be used to handle the case that the height of the shelf is changed. The motion plan modification is similar.

(4.2) Algorithm for Getting Position and Orientation Offsets Between Base-Case Motion Plan and Run Time Motion Plan

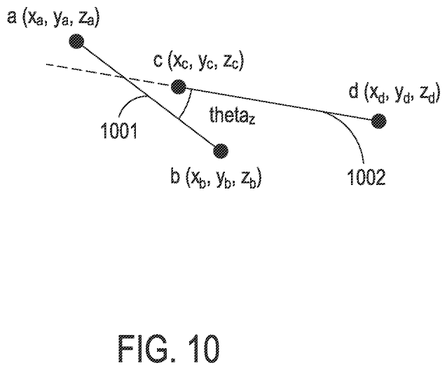

In the base-case motion plan, the base-case marker information is associated with each action. This along with the run time marker information detected at run time is used to calculate the position offset and orientation offset and to be applied to modify the base-case motion plan, in which the first pose-aware actions are accordingly modified into the second pose-aware actions. Please refer to FIG. 10. FIG. 10 schematically illustrates a difference between the marker information respectively in the base-case motion plan and the run time motion plan. As shown in FIG. 10, a and b are the left and right marker positions in the base-case motion plan 1001, c and d are the left and right marker positions detected for the run time motion plan 1002, respectively.

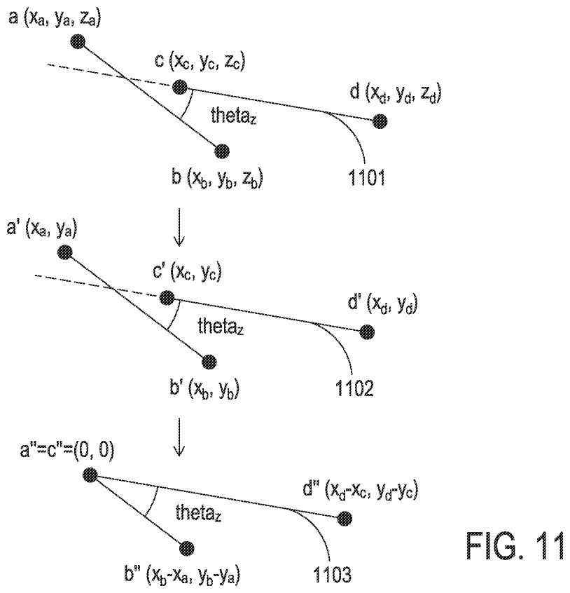

Please refer to FIG. 11. The idea of calculating position and orientation offsets is shown in FIG. 11. Note that the positions are based on the mobile manipulator's coordinate. The numeral symbol 1101 indicates the relationship between the marker positions, which has already been shown in FIG. 10. The position offset is from c to a and orientation offset is theta_{z}. From here, the height information (Z) is dropped due to the assumption that the environment within a factory or warehouse is a flat plane. This results in the relationship 1102, in which the symbols a, b, c, and d are mapped to the symbols a′, b′, c′, and d′, respectively. The symbols a′, b′, c′, and d′ only contain 2-dimension information (X and Y). Note that this is a projection onto the X-Y plane. Next, a′ and c′ are translated to O (0, 0) and the same translation matrices are applied to b′ (a′ to O) and d′ (c′ to O) and resulting in symbols a″, b″, c″, and d″ in the relationship 1103. Then the calculation of position and orientation offsets can be done using the formulas below.

Input:

a=(xₐ,yₐ,zₐ), b=(x_{b},y_{b},z_{b}), c=(x_{c},y_{c},z_{c}), d=(x_{d},y_{d},z_{d})

Position Offset:

(Δₓ,Δ_{y},0)=(x_{c}−xₐ,y_{c}−yₐ,0)

Orientation Offset:

$${theta}_{z} = {cos}^{- 1} \frac{r \cdot s}{\vert r \vert \cdot \vert s \vert}$$

where:

r=(xᵣ,yᵣ)=(x_{b}−xₐ,y_{b}−yₐ)

s=(xₛ,yₛ)=(x_{d}−x_{c},y_{d}−y_{c})

r·s=xᵣxₛ+yᵣyₛ

|r|·|s|=\sqrt{xᵣ²+yᵣ²}+\sqrt{xₛ²+yₛ²}

(4.3) Algorithms for Modifying Base-Case Motion Plan

With position offset (Δₓ, Δ_{y}, 0) and orientation offset theta_{z}, the base-case motion plan can now be adjusted into the run time motion plan for performing the manipulation. Only pose-aware actions in the motion plan are required to be modified, at least including “moving EFF to a pose”, “EFF traversing through a trajectory” and “EFF moving with position offset with respect to target's coordinate” (refer to Table I). The calculations of adjustment are described in Sections 4.3.1 and 4.3.2.

(4.3.1) EFF Pose and Trajectory

For action type “moving EFF to a pose”, a single EFF pose needs to be modified. On the other hand, “EFF traversing through a trajectory” action contains a series of EFF poses and each needs to be recalculated. Hence both can use the same algorithm to calculate new target EFF pose as presented below.

Input:

EFF Pose in Base-Case Motion Plan

pose(p,q),p=(x,y,z),q=(qₓ,q_{y},q_{z},q_{w})

Marker Information in Base-Case Motion Plan

l=(xₗ,yₗ,zₗ), r=(xᵣ,yᵣ,zᵣ)

| | |
|---|---|
| Position offset from Section 4.2 | (Δₓ, Δ_{y}, 0) |
| Rotation offset from Section 4.2 | θ = theta_{z} |
| Quaternion rotation equivalent to θ | qᵣ |

Algorithm:
1. Translate l,p to origin of XY plane: l′=(0, 0, zₗ)

p′=(x_{p′},y_{p′},zₚ)=(x−xₐ,y−yₐ,z)
2. Rotate p′ by θ above z axis:

p″=(x_{p′}cos θ−y_{p′}sin θ,x_{p′},sin θ+y_{p′}cos θ,zₚ)=(x_{p″},y_{p″},zₚ)
3. Translate p″ back and add offset to get new target pose:

pⁿ=(x_{p″}+xₐ+Δₓ,yₚ″+yₐ+Δ_{y},zₚ)
4. Apply qᵣ to q, where x denotes quaternion multiplication

qⁿ=qᵣ×q

Output:
Final EFF pose (pⁿ, qⁿ)

(4.3.2) Movement Position Offset

Action type “EFF moving with position offset with respect to target's coordinate” can be calculated using the equations calculating of new EFF movement offset as following.

Input:

EFF Movement in Base-Case Motion Plan

Δ=(Δₓ,Δ_{y},Δ_{z})

Rotation (about Z axis) θ=theta_{z}

Algorithm:

New EFF movement Δ′=(Δ′ₓ,Δ′_{y},Δ′_{z})

where: Δ′ₓ=Δₓ cos θ−Δ_{y} sin θ

Δ′_{y}=Δₓ sin θ+Δ_{y} cos θ

Δ′_{z}=Δ_{z}

To summarize, this framework provides a process to create a base-case motion plan according to the base-case marker information. Then, with the run time marker information obtained through the method using two squared fiducial markers provided in the present disclosure, the base-case motion plan can be adjusted into the run time motion plan using the methods provided to compensate both position and orientation offsets.

In brief, the present disclosure has the following advantages:

1. Low cost: the cost for setup the system is affordable, which includes RGB camera and cost to print the markers.

2. Easy deployment: markers can be easily deployed to the field within the view of camera, and there is no requirement on measurement and alignment.

3. Accuracy: multi-marker system from this disclosure provides good accuracy on finding position offset and orientation offset with respect to the base-case motion plan.

4. A method (“teaching”) for creating the base-case motion plan makes it realistic to be adopted in the industrial without a research team.

5. Local information for manipulation: only local information for manipulation is used and stored in this disclosure, which is relatively cheaper than constructing an accurate global 3D environmental map and makes re-arrangement of the environmental settings easy.

From the above descriptions, the present disclosure provides an adaptive mobile manipulation method which classifies the actions for object manipulation into pose-aware actions and non-pose-aware actions and further associates the pose-aware actions with localization information obtained by detecting the markers, and thus, the pose-aware actions with high accuracy can be achieved through a low-cost framework of an adaptive manipulation apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An adaptive mobile manipulation method, comprising steps of:
providing a mobile manipulation apparatus comprising a manipulator, a sensor and a processor for a manipulation of an object placed on a carrier having a plurality of markers spaced apart from each other;
providing a base-case motion plan comprising a plurality of first pose-aware actions;
the sensor detecting the plurality of markers to obtain a run time marker information;
the processor, according to the base-case motion plan, generating a run time motion plan, wherein the run time motion plan comprises a plurality of second pose-aware actions, and the plurality of second pose-aware actions are modified from the plurality of first pose-aware actions according to the run time marker information; and
the processor further executing the run time motion plan for controlling the manipulator to manipulate the object.

2. The method as claimed in claim 1, wherein each of the first pose-aware actions of the base-case motion plan comprises variables and a base-case marker information corresponding to the plurality of markers.

3. The method as claimed in claim 2, further comprising steps of:
the processor calculating a difference between the base-case marker information and the run time marker information; and
the processor generating the plurality of second pose-aware actions according to the plurality of first pose-aware actions and the difference.

4. The method as claimed in claim 2, wherein both the run time marker information and the base-case marker information comprise positions and orientations between the plurality of markers and the sensor.

5. The method as claimed in claim 1, wherein the manipulator further comprises an end effector and a joint.

6. The method as claimed in claim 5, wherein the first and the second pose-aware actions respectively comprise moving the end effector by position and orientation relative to the object.

7. The method as claimed in claim 6, wherein the first and the second pose-aware actions respectively comprise at least one of the following actions:
moving the end effector to a target pose;
traversing the end effector through a trajectory; and
moving the end effector associating with the run time marker information.

8. The method as claimed in claim 1, wherein the object is placed at a fixed location on the carrier.

9. The method as claimed in claim 1, wherein the markers comprise visual markers or fiducial markers.

10. The method as claimed in claim 1, wherein the sensor comprises a camera.

11. An adaptive mobile manipulation apparatus, comprising:
a manipulator;
a sensor; and
a processor, coupled to the manipulator and the sensor, configured to perform the following steps:
retrieving a base-case motion plan comprising a plurality of first pose-aware actions;
driving the sensor to detect a plurality of markers located on a carrier to obtain a run time marker information;
according to the base-case motion plan, generating a run time motion plan, wherein the run time motion plan comprises a plurality of second pose-aware actions, and the plurality of second pose-aware actions are modified from the plurality of first pose-aware actions according to the run time marker information; and
executing the run time motion plan for controlling the manipulator to manipulate an object placed on the carrier.

12. The mobile manipulation apparatus as claimed in claim 11, wherein the sensor comprises a camera.

13. The mobile manipulation apparatus as claimed in claim 11, wherein the markers comprise visual markers or fiducial markers.
